(19) United States
(12) Patent Application Publication
(10) Pub. No.: US 2026/0247044 A1
(43) Pub. Date: Aug. 20, 2026

(54) INFORMATION PROCESSING DEVICE, SYSTEM, INFORMATION PROCESSING METHOD, INFORMATION PROCESSING PROGRAM, AND COMPUTER SYSTEM

(71) Applicant: Sony Interactive Entertainment Inc., Tokyo (JP)

(72) Inventors: Hideaki Iwaki, Kanagawa (JP); Naoyuki Miyada, Tokyo (JP)

(73) Assignee: Sony Interactive Entertainment Inc., Tokyo (JP)

(21) Appl. No.: 19/160,956

(22) PCT Filed: Mar. 17, 2023
(86) PCT No.: PCT/JP2023/010679

§ 371 Date: Aug. 29, 2025

(51) Int. Cl. H04N 25/47; G06T 7/20; G06T 7/70

(52) U.S. Cl. CPC H04N 25/47; G06T 7/20; G06T 7/70

(57) ABSTRACT

Provided is an information processing device including a detection section that detects an attention point in a detection target on the basis of an output of a first sensor, a correction section that corrects a detection result obtained by the detection section, and a correction value calculation section that calculates a correction value in the correction section on the basis of an event signal generated with temporal correlation with time for specifying the output of the first sensor among event signals generated by a second sensor including an event-based sensor for asynchronously generating event signals when detecting a change in the intensity of light incident on each pixel.

### TECHNICAL FIELD

The present invention relates to an information processing device, a system, an information processing method, an information processing program, and a computer system.

### BACKGROUND ART

An event-based sensor in which a pixel that detects a change in the intensity of incident light generates a signal asynchronously in time has been known. The event-based sensor is advantageous in that it can operate at high speeds with low power in comparison with a frame-based vision sensor, specifically, an image sensor such as a charge-coupled device (CCD) and a complementary metal-oxide-semiconductor (CMOS), which scans all pixels for each predetermined cycle. The techniques related to such an event-based sensor are described in, for example, PTL 1 and PTL 2.

### CITATION LIST

### Patent Literature

### [PTL 1]

Japanese Translations of PCT for Patent No. 2014-535098

### [PTL 2]

Japanese Patent Laid-open No. 2018-85725

### SUMMARY

### Technical Problem

However, although the above-described advantage of the event-based sensor has been known, it is difficult to say that a utilization method in combination with other devices has been sufficiently proposed.

Therefore, an object of the present invention is to provide an information processing device, a system, an information processing method, an information processing program, and a computer system that can perform detection with high accuracy by detecting an attention point in a detection target by using a sensor and an event-based sensor both of which perform an output with temporal correlation with each other.

### Solution to Problem

According to an aspect of the present invention, provided is an information processing device including a detection section that detects an attention point in a detection target on the basis of an output of a first sensor, a correction section that corrects a detection result obtained by the detection section, and a correction value calculation section that calculates a correction value in the correction section on the basis of an event signal generated with temporal correlation with time for specifying the output of the first sensor among event signals generated by a second sensor including an event-based sensor for asynchronously generating event signals when detecting a change in intensity of light incident on each pixel.

According to another aspect of the present invention, provided is a system including a first sensor, a second sensor that includes an event-based sensor for asynchronously generating event signals when detecting a change in intensity of light incident on each pixel, a detection section that detects an attention point in a detection target on the basis of an output of the first sensor, a correction section that corrects a detection result obtained by the detection section, and a correction value calculation section that calculates a correction value in the correction section on the basis of the event signal generated with temporal correlation with time for specifying the output of the first sensor among the event signals.

According to still another aspect of the present invention, provided is an information processing method including a first reception step of receiving an output of a first sensor, a second reception step of receiving event signals generated by a second sensor including an event-based sensor for asynchronously generating event signals when a change in intensity of light incident on each pixel is detected, a detection step of detecting an attention point in a detection target on the basis of the output of the first sensor, a correction step of correcting a detection result in the detection step, and a correction value calculation step of calculating a correction value in the correction step on the basis of the event signal generated with temporal correlation with time for specifying the output of the first sensor among the event signals.

According to still another aspect of the present invention, provided is an information processing program that causes a computer to realize a function of receiving an output of a first sensor, a function of receiving event signals generated by a second sensor including an event-based sensor for asynchronously generating event signals when a change in intensity of light incident on each pixel is detected, a function of detecting an attention point in a detection target on the basis of the output of the first sensor, a function of correcting a detection result, and a function of calculating a correction value when the detection result is corrected, on the basis of the event signal generated with temporal correlation with time for specifying the output of the first sensor among the event signals.

According to still another aspect of the present invention, provided is a computer system including at least one memory for storing a program code, and at least one processor for processing the program code to execute an operation, in which the operation includes receiving an output of a first sensor, receiving event signals generated by a second sensor including an event-based sensor for asynchronously generating event signals when a change in intensity of light incident on each pixel is detected, detecting an attention point in a detection target on the basis of the output of the first sensor, correcting a detection result, and calculating a correction value when the detection result is corrected, on the basis of the event signal generated with temporal correlation with time for specifying the output of the first sensor among the event signals.

### BRIEF DESCRIPTION OF DRAWINGS

FIG. 1 is a block diagram for depicting an outline configuration of a system according to a first embodiment of the present invention.

FIG. 2 is a diagram for explaining an example of detecting a person in the first embodiment of the present invention.

FIG. 3 is a flowchart for depicting an example of a processing method according to the first embodiment of the present invention.

FIG. 5 is a flowchart for depicting an example of the processing method according to the first embodiment of the present invention.

FIG. 5 is a diagram for explaining a relation between an RGB image signal and an event signal in a second embodiment of the present invention.

FIG. 6 is a flowchart for depicting an example of the processing method according to the second embodiment of the present invention.

FIG. 7 is a block diagram for depicting an outline configuration of a detection section according to a third embodiment of the present invention.

FIG. 8 is another flowchart for depicting an example of the processing method according to the third embodiment of the present invention.

FIG. 9 is another block diagram for depicting an outline configuration of a system according to each embodiment of the present invention.

FIG. 10 is a flowchart for depicting an example of the processing method according to each embodiment of the present invention.

FIG. 11 is another flowchart for depicting an example of the processing method according to each embodiment of the present invention.

### DESCRIPTION OF EMBODIMENTS

Hereinafter, several embodiments of the present invention will be described in detail with reference to the accompanying drawings. It should be noted that, in the present specification and the drawings, constitutional elements having substantially the same functional configurations will be denoted by the same reference signs, and duplicate descriptions will be omitted.

### First Embodiment

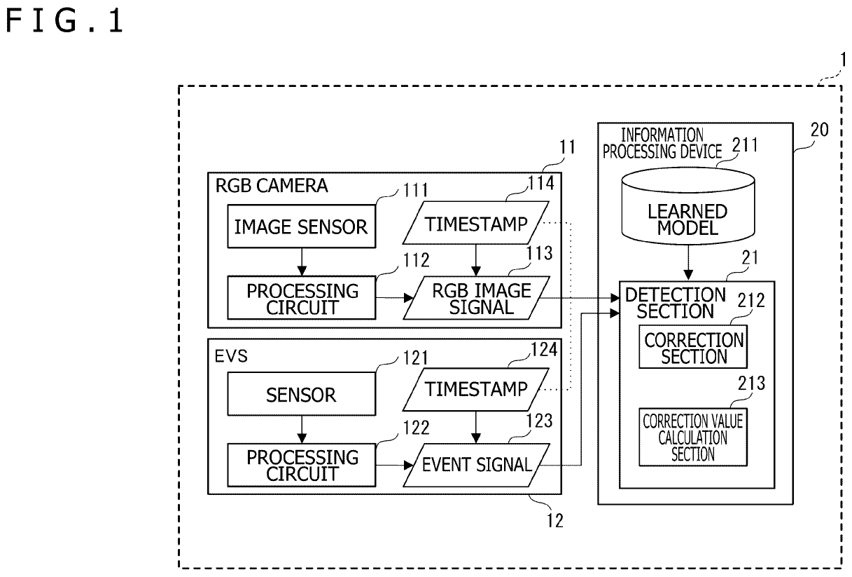

FIG. 1 is a block diagram for depicting an outline configuration of a system according to a first embodiment of the present invention.

A system 1 includes an RGB camera 11, an event-based vision sensor (EVS) 12, and an information processing device 20.

The RGB camera 11 includes an image sensor 111 that is a first sensor and a processing circuit 112 connected to the image sensor 111. The image sensor 111 generates an RGB image signal 113 by scanning all pixels synchronously in time, for example, at a predetermined cycle or at a predetermined timing according to a user operation. The processing circuit 112 converts, for example, the RGB image signal 113 into a format suitable for storage and transmission. In addition, the processing circuit 112 gives a timestamp 114 to the RGB image signal 113.

The EVS 12 is an example of a second sensor that generates an event signal when the sensor detects a change in the intensity of light, and is an example of a sensor also referred to as a dynamic vision sensor (DVS) or an event-based vision sensor (EVS). The EVS 12 includes a sensor 121 that is the second sensor configuring a sensor array, and a processing circuit 122 connected to the sensor 121. The sensor 121 is an event-based sensor that includes a light receiving element and generates an event signal 123 when detecting a change in the intensity of light incident on a pixel basis, more specifically, a change in luminance exceeding a preset predetermined value. Since the sensor 121 that does not detect a change in the intensity of incident light does not generate the event signal 123, the event signal 123 is generated asynchronously in time in the EVS 12.

The event signal 123 output via the processing circuit 122 includes identification information (for example, the position of a pixel) of the sensor 121, polarity (rise or fall) of a change in luminance, and a timestamp 124. In addition, when a change in luminance is detected, the EVS 12 can generate the event signal 123 at a frequency significantly higher than the generation frequency of the RGB image signal 113 (the frame rate of the RGB camera 11).

In the present embodiment, the timestamp 114 given to the RGB image signal 113 and the timestamp 124 given to the event signal 123 are associated with each other in time. Specifically, for example, by providing time information used to generate the timestamp 124 by the EVS 12 to the RGB camera 11, the timestamp 114 can be associated with the timestamp 124. Alternatively, in the case where time information for generating the timestamps 114 and 124 is independent between the RGB camera 11 and the EVS 12, the offset amount of the timestamps is calculated on the basis of the time when a specific event (for example, a change in a subject throughout an image) occurred, so that the timestamp 114 and the timestamp 124 can be associated with each other after the occurrence.

In addition, in the present embodiment, the sensor 121 of the EVS 12 is associated with one or more pixels of the RGB image signal 113, and the event signal 123 is generated according to a change in the intensity of light in one or more pixels of the RGB image signal 113, by the calibration procedures of the RGB camera 11 and the EVS 12 executed in advance. More specifically, for example, the sensor 121 can be associated with one or more pixels of the RGB image signal 113 by imaging a common calibration pattern between the RGB camera 11 and the EVS 12 and calculating association parameters between the camera and the sensor from internal parameters and external parameters of the RGB camera 11 and the EVS 12.

The information processing device 20 is implemented, for example, by a computer having a communication interface, a processor, and a memory, and includes a function of a detection section 21 realized in such a manner that a processor for processing program codes to execute operations is operated according to a program stored in a memory or received via a communication interface.

As depicted in FIG. 1, the detection section 21 is provided with a correction section 212 and a correction value calculation section 213.

The detection section 21 detects an attention point in a detection target on the basis of the RGB image signal 113 generated by the image sensor 111 that is the first sensor and corrects a detection result on the basis of the event signal 123 generated by the sensor 121 that is the second sensor. In the present embodiment, a case where the detection target is a person will be described as an example. The detection section 21 uses at least one joint of a person who is the detection target as an attention point and calculates coordinate information thereof.

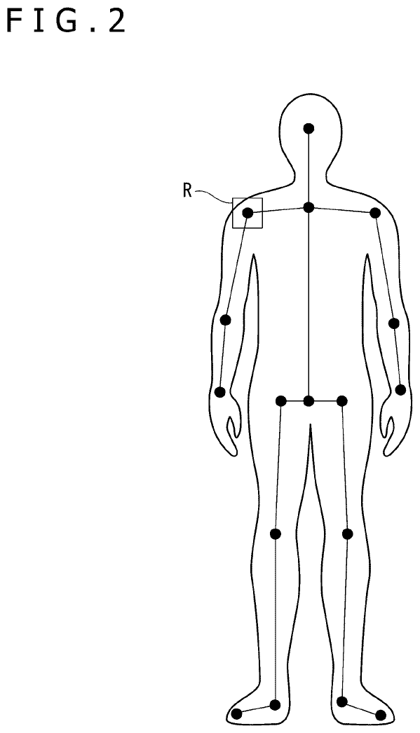

FIG. 2 is a diagram for explaining an example of detecting a person. As depicted in FIG. 2, the detection section 21 uses a plurality of joints of the person as attention points and calculates coordinate information of each joint. The example in FIG. 2 depicts an example in which 17 joints such as the head, shoulders, elbows, wrists, knees, ankles, and toes are used as the attention points.

On the basis of, for example, a learned model 211, the detection section 21 uses a plurality of joints of a user from the RGB image signal 113 as the attention points and calculates coordinate information indicating the position of each joint. The learned model 211 can be constructed in advance by, for example, executing supervised learning in which an image of a person having a plurality of joints is used as input data, the plurality of joints of the person are used as the attention points, and coordinate information indicating the position of each joint is used as correct answer data. It should be noted that a detailed description of specific methods of machine learning is omitted because various known techniques can be used. In addition, the detection section 21 may be provided with a relation learning section, and each time the RGB image signal 113 is input, the learned model 211 may be updated by learning the relation between an image based on the input RGB image signal 113 and coordinate information indicating the positions of the joints.

In addition, the event signal 123 may be used when processing is performed by the detection section 21. For example, an object existing in a continuous pixel region where occurrence of an event of the same polarity is depicted in the event signal 123 may be detected as a person, and the detection processing described above may be performed for the corresponding part of the RGB image signal 113.

The detection section 21 may set an interest region including at least a part of the detection target. The interest region is a region including at least a part of the detection target, and is an attention region to be subjected to tracking processing or the like. As depicted in, for example, FIG. 2, for each attention point (joint) of the person, the detection section 21 sets a square having a predetermined size centering on the attention point as an interest region R. It should be noted that, in the example of FIG. 2, the interest region R is illustrated only for the attention point of one shoulder, but the detection section 21 may set the interest region R for each of all the attention points of the person, or may set the interest region R only for some of the attention points. It may be possible for the user to specify to which attention point the interest region R is set.

As described above, the detection section 21 detects an attention point in a detection target on the basis of the RGB image signal 113 generated by the image sensor 111 that is the first sensor and corrects a detection result on the basis of the event signal 123 generated by the sensor 121 that is the second sensor. At the time of k, the detection section 21 detects the attention point in the interest region R and corrects the detection result in the case where the interest region R has been set on the basis of the RGB image signal 113 of the previous frame or the like. It should be noted that, in the case where a plurality of interest regions R have been set, the detection section 21 detects the attention point for each interest region and corrects the detection result.

The correction section 212 corrects the detection result in the detection section 21. More specifically, the correction section 212 corrects the coordinate information of the attention point detected by the detection section 21 on the basis of a correction value calculated by the correction value calculation section 213 to be described later. The correction section 212 corrects the correction result in the detection section 21 by, for example, performing filter processing on the coordinates of the attention point. The filter processing includes, for example, low-pass filter processing and high-pass filter processing.

For example, in the low-pass filter processing, the detection result in the detection section 21 can be corrected by changing the cutoff frequency. In the case where the movement speed of the detected attention point is small or close to 0, jitter that is a temporal deviation or fluctuation is included in the detection result. In such a case, for example, in the case where correction is performed using what is called Euro Filter, which changes the cutoff frequency according to the movement speed of the detected attention point itself, the jitter is directly reflected in the cutoff frequency. As a result, it is not possible to correct or suppress the jitter generated at the attention point when the movement speed of the detected attention point is small or close to 0, that is, in a stationary state. Therefore, the influence of the jitter actually remains at the attention point in the stationary state even after correction.

Thus, the correction section 212 performs correction using what is called One Yen Filter, which changes the cutoff frequency on the basis of the event signal 123 generated by the sensor 121 that is the second sensor. Since the event signal 123 is acquired independently of the RGB image signal 113, the jitter described above does not affect the correction value, and by calculating the correction value on the basis of the event signal 123, suitable correction can be performed even in the case where the movement speed of the detected attention point is small or close to 0.

The correction value calculation section 213 calculates the correction value in the correction section 212 on the basis of the event signal 123 generated with temporal correlation with time for specifying the RGB image signal 113 referred to when detecting the attention point to be corrected by the correction section 212 among the event signals 123 generated by the sensor 121 that is the second sensor. The time for specifying the RGB image signal 113 is, for example, the exposure start time of the image sensor 111, the output time of the RGB image signal 113, the generation time of an image based on the RGB image signal 113, and the like. For example, when detecting the attention point, the detection section 21 refers to the event signal 123 to which a timestamp associated with the timestamp given to the RGB image signal 113 referred to by the detection section 21 is given.

The correction value calculation section 213 calculates, for example, an optical flow indicating the movement of the attention point on the basis of a plurality of event signals 123, and calculates the above-described correction value on the basis of the calculated optical flow. At this time, the correction value calculation section 213 calculates the correction value on the basis of the optical flow such that the degree of correction is made smaller as the movement speed of the attention point is larger and the degree of correction is made larger as the movement speed is smaller. By calculating the correction value in this way, it is possible to correct or suppress the jitter generated at the attention point when the movement speed of the detected attention point is small or close to 0, that is, in a stationary state.

In the case where the correction section 212 performs correction by filter processing, the correction value calculation section 213 calculates, for example, the cutoff frequency in the filter processing as the correction value. The correction value calculation section 213 calculates the cutoff frequency by, for example, multiplying a variable parameter β by the movement speed of the attention point. The variable parameter β may be settable by the user.

It should be noted that, as described above, the timestamp 114 given to the RGB image signal 113 and the timestamp 124 given to the event signal 123 basically have temporal correlation. However, depending on the characteristics or state of the detection target, the correlation between them may include a time deviation.

In such a case, even though the movement speed of the attention point calculated on the basis of the event signal 123 is 0 or almost 0, the position of the attention point detected on the basis of the continuously detected RGB image signals 113 may change. In the case where the position of the attention point changes, if the correction value calculation section 213 calculates the cutoff frequency by multiplying the variable parameter β by the movement speed of the attention point as described above, an appropriate cutoff frequency, that is, the correction value, cannot be calculated.

In order to avoid such a problem, at the timing when the attention point is detected on the basis of the RGB image signal 113, the correction value calculation section 213 may monitor the positional difference between the attention point (the attention point detected on the basis of the RGB image signal 113 in the previous frame) detected on the basis of the RGB image signal 113 last time and the attention point detected on the basis of the RGB image signal 113 this time. Then, in the case where the positional difference is equal to or larger than a predetermined threshold value and the movement speed of the attention point calculated on the basis of the event signal 123 is 0 or almost 0, the correction value calculation section 213 calculates the cutoff frequency by multiplying a variable parameter γ different from the variable parameter β by the positional difference, instead of calculating the cutoff frequency by multiplying the variable parameter β by the movement speed of the attention point described above, and in other cases, the cutoff frequency may be calculated by multiplying the variable parameter β by the movement speed of the attention point described above. It should be noted that the variable parameter γ may be settable by the user similarly to the variable parameter β.

With such a configuration, even if the movement speed of the attention point calculated on the basis of the event signal 123 is 0 or almost 0, an appropriate cutoff frequency, that is, the correction value, can be calculated in the case where the positional difference between the attention points detected on the basis of the RGB image signals 113 occurs.

As described so far, the detection section 21 detects the attention point the RGB image signal 113, and the correction section 212 corrects the coordinate information of the attention point detected by the detection section 21 on the basis of the correction value calculated by the correction value calculation section 213 on the basis of the event signal 123. Therefore, the detection result of the attention point based on the RGB image signal 113 can be suitably corrected on the basis of the event signal 123.

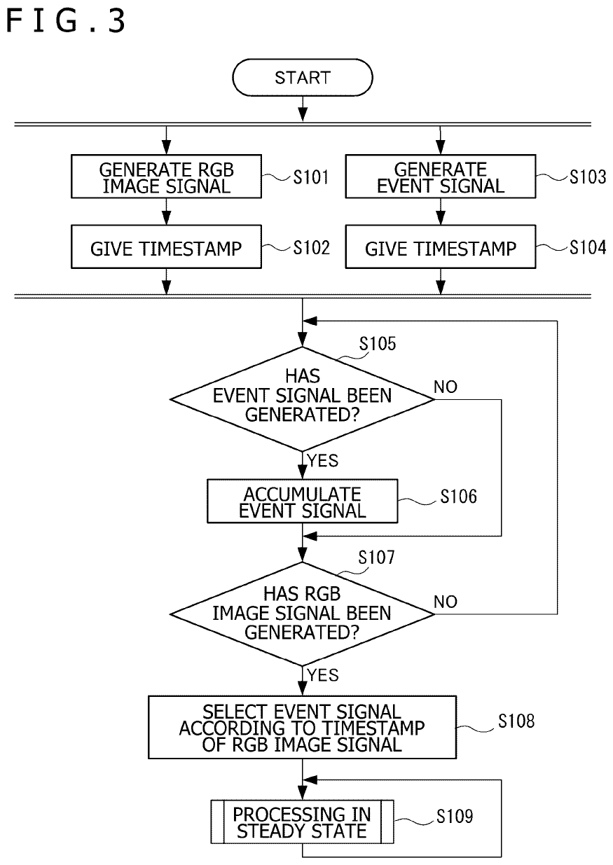

FIG. 3 and FIG. 4 are flowcharts for depicting an example of processing according to the first embodiment of the present invention. In the example of FIG. 3, the RGB camera 11 generates the RGB image signal 113 (Step S101), and the timestamp 114 is given to the generated RGB image signal 113 (Step S102). Meanwhile, the EVS 12 generates the event signal 123 in parallel to the generation of the RGB image signal 113 in time (Step S103), and the timestamp 124 is given to the generated event signal 123 (Step S104). The timestamp 114 given to the RGB image signal 113 and the timestamp 124 given to the event signal 123 have temporal correlation. That is, by referring to the timestamp 114 and the timestamp 124, it is possible to later identify the event signal 123 generated with temporal correlation with time for specifying the RGB image signal 113. It should be noted that Step S103 in which the event signal 123 is generated is executed only in the case where the sensor 121 associated with one or more pixels of the RGB image signal 113 detects a change in the intensity of light. That is, for example, in the case where there is a movement of the attention point, a plurality of event signals 123 are generated while the RGB image signal 113 is generated once.

The detection section 21 determines whether or not the event signal 123 has been generated by the EVS 12 (Step S105), and if it is determined that the event signal 123 has been generated (YES in Step S105), the generated event signal 123 is accumulated in a buffer that is not illustrated (Step S106). It should be noted that the timestamp 124 is given to the event signal 123 as described above.

If it is determined that the event signal 123 is not generated after a predetermined period of time elapses (NO in Step S105), the detection section 21 determines whether or not the RGB image signal 113 has been generated by the RGB camera 11 (Step S107), and if it is determined that the RGB image signal 113 has been generated (YES in Step S107), the flow proceeds to Step S108 to be described later. In contrast, if it is determined that the RGB image signal 113 is not generated after a predetermined period of time elapses (NO in Step S107), the detection section 21 returns to Step S105. That is, until the RGB image signal 113 is generated, the detection section 21 accumulates the event signal 123 in a buffer, which is not illustrated, each time the event signal 123 is generated.

If it is determined that the RGB image signal 113 has been generated (YES in Step S107), the detection section 21 selects some of the event signals 123 from those accumulated in the buffer according to the timestamp 114 given to the generated RGB image signal 113 (Step S108).

As described above, the event signal 123 is generated prior to the RGB image signal 113. Therefore, the detection section 21 refers to the timestamp 114 given to the generated RGB image signal 113 and the timestamp 124 given to the event signal 123, and selects the event signal 123 generated with temporal correlation with time for specifying the generated RGB image signal 113. By making such a selection, the event signal 123 generated without temporal correlation with time for specifying the generated RGB image signal 113 can be excluded, and the RGB image signal 113 and the event signal 123 can have temporal correlation. It should be noted that the event signal 123 that has not been selected may be processed in any manner such as being erased from the buffer.

The series of processing from Step S105 to Step S108 described so far is an initial processing procedure for allowing the RGB image signal 113 and the event signal 123 to have temporal correlation. The method of the initial processing procedure is not limited to this example.

Further, the detection section 21 executes processing in the steady state (Step S109).

In the example of FIG. 4, in the processing in the steady state described in Step S109 of FIG. 3, the detection section 21 detects the attention point on the basis of the RGB image signal 113 (Step S201), and sets the interest region R for each detected attention point (Step S202).

Next, the correction value calculation section 213 of the detection section 21 calculates an optical flow on the basis of the event signal 123 (Step S203), and calculates the movement speed of the attention point on the basis of the optical flow (Step S204). In calculating the optical flow and the movement speed, the correction value calculation section 213 calculates the optical flow and the movement speed on the basis of the event signal 123 generated with temporal correlation with time for specifying the RGB image signal 113 referred to when detecting the attention point in Step S201.

Then, the correction value calculation section 213 calculates the correction value on the basis of the calculated movement speed (Step S205).

Next, the correction section 212 corrects the attention point detected in Step S201 on the basis of the correction value calculated in Step S205 (Step S206).

It should be noted that, in the case where the detection section 21 detects a plurality of attention points in Step S201, the correction value calculation section 213 calculates the correction value for each detected attention point, and the correction section 212 performs correction for each detected attention point.

Next, the detection section 21 determines whether or not the RGB image signal 113 has been generated by the RGB camera 11 (Step S207), and if it is determined that the next RGB image signal 113 has been generated (YES in Step S207), the flow returns to Step S201. That is, the detection section 21 repeatedly executes the processing from Step S201 to Step S207 each time the RGB image signal 113 is generated, detects the attention point on the basis of the generated RGB image signal 113, calculates the correction value on the basis of the event signal 123 generated with temporal correlation, and corrects the detected attention point on the basis of the RGB image signal 113.

In the first embodiment of the present invention as described above, the attention point in the detection target is detected on the basis of the RGB image signal 113 that is an output of the first sensor (image sensor 111), the correction value is calculated on the basis of the event signal 123 generated with temporal correlation with time for specifying the RGB image signal 113 among the event signals 123 generated by the second sensor (sensor 121), and the detection result is corrected on the basis of the correction value.

Therefore, it is possible to detect the attention point on the basis of the RGB image signal 113 that is an output of the first sensor and calculate the correction value for correcting the detection result on the basis of the event signal 123 generated with temporal correlation. That is, the detection result of the attention point based on the output of the first sensor is corrected on the basis of the event signal 123 acquired independently of and with temporal correlation with the output of the first sensor. Therefore, even in the case where the detection result of the attention point based on the output of the first sensor includes the jitter that is a temporal deviation or fluctuation, the jitter can be corrected or suppressed. Thus, the detection can be performed with high accuracy.

In addition, in the first embodiment of the present invention, an optical flow indicating the movement of the attention point is calculated on the basis of a plurality of event signals 123, and the correction value is calculated on the basis of the calculated optical flow. Therefore, the correction value without the influence of the jitter can be calculated according to the movement of the attention point.

In addition, in the first embodiment of the present invention, the movement speed of the attention point is calculated on the basis of the optical flow, the degree of correction is made smaller as the movement speed is larger, and the degree of correction is made larger as the movement speed is smaller. Therefore, the correction value capable of correcting or suppressing the jitter generated at the attention point when the movement speed of the detected attention point is small or close to 0, that is, in a stationary state, can be calculated, and correction according to the movement speed of the detected attention point can be performed.

In addition, in the first embodiment of the present invention, correction is performed by calculating the cutoff frequency in the filter processing (for example, low-pass filter processing) as the correction value and performing the filter processing on the attention point. Thus, suitable correction according to the attention point can be performed.

In addition, in the first embodiment of the present invention, the detection target is a person, and the detection section 21 calculates coordinate information of at least one joint of the person. Thus, the detection can be performed with high accuracy by using the person as the detection target.

In addition, in the first embodiment of the present invention, the first sensor includes the image sensor 111 that is an image sensor for generating image signals. Thus, the attention point is detected by using the RGB image signal 113 that has a relatively large amount of information, the correction value is calculated on the basis of the event signal 123 generated with temporal correlation with time for specifying the RGB image signal 113 among the event signals 123 generated by the second sensor (sensor 121), and the detection result is corrected on the basis of the correction value. Therefore, it is possible to correct or suppress the jitter generated at the attention point when the movement speed of the attention point is small or close to 0, that is, in a stationary state, in comparison with the detection using only the RGB image signal 113. Thus, the detection can be performed with high accuracy.

### Second Embodiment

Hereinafter, a second embodiment of the present invention will be described with reference to the drawings. In the second embodiment, only the parts different from those in the first embodiment will be described, and the description of the parts similar to those in the first embodiment will be omitted. In addition, in the second embodiment, the constitutional elements having substantially the same functional configurations as those in the first embodiment will be denoted by the same reference signs.

In the second embodiment, the detection section 21 detects the attention point on the basis of the event signal 123 generated by the sensor 121 that is the second sensor, in addition to the RGB image signal 113 generated by the image sensor 111 that is the first sensor.

The detection section 21 selects whether to refer to the RGB image signal 113 or whether to refer to the event signal 123 when detecting the attention point according to the timing when the image sensor 111 generates the RGB image signal 113.

In the RGB camera 11, as described above, the image sensor 111 scans all the pixels synchronously in time to generate the RGB image signal 113 at a constant frame rate. Then, on the basis of the RGB image signal 113 generated by the RGB camera 11, the detection section 21 calculates coordinate information of the attention point of the person as the detection target, and sets the interest region R including at least a part of the detection target.

Meanwhile, in the EVS 12, in the case where the posture or position of the person who is the user changes, a change in luminance occurs, and the sensor 121 asynchronously generates the event signal 123 at the pixel address where the change in luminance has occurred.

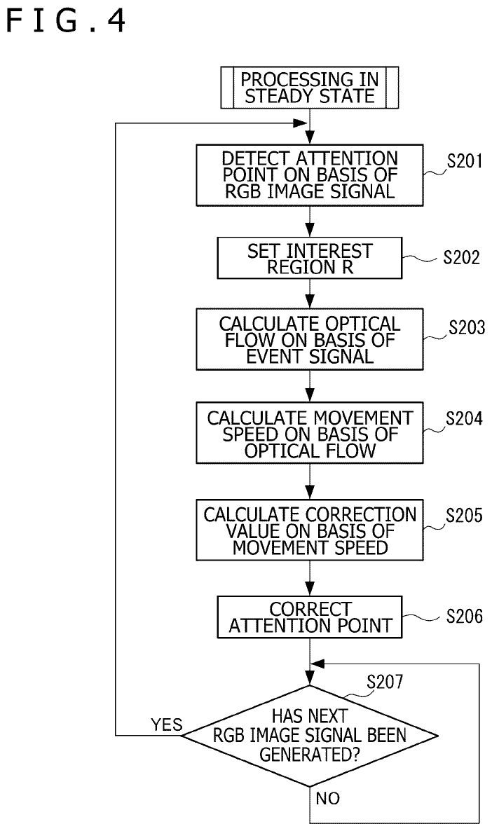

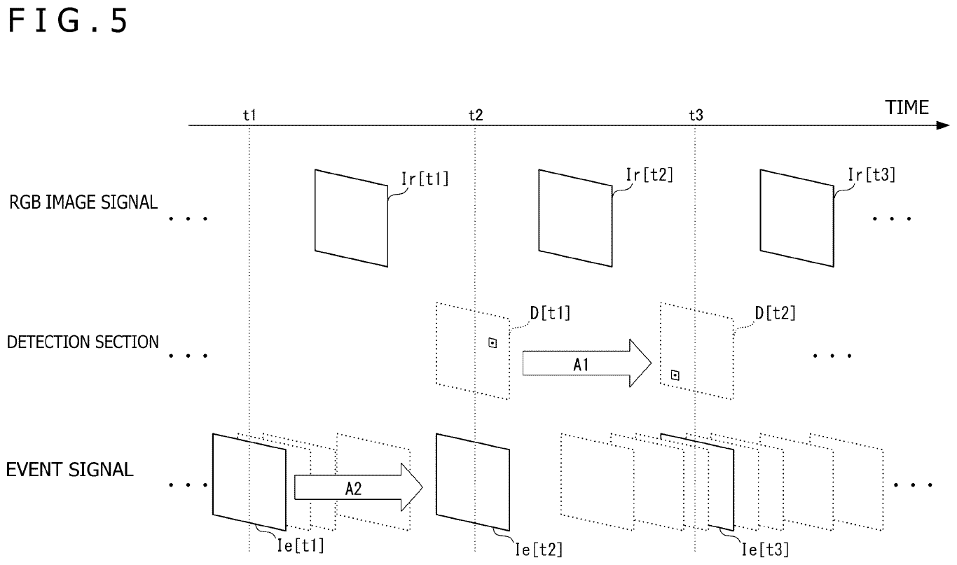

FIG. 5 is a diagram for explaining the relation between the RGB image signal 113 and the event signal 123. In FIG. 5, Ir[tx] indicates the RGB image signal 113 having a timestamp associated with time x, and Ie[tx] indicates the event signal 123 having a timestamp associated with the time x. In addition, for the purpose of explanation, FIG. 5 illustrates an example of a case where the event signals 123 are also generated at predetermined times (t1, t2, and t3) when the RGB image signals 113 are generated, the event signals 123 generated at the predetermined times (t1, t2, and t3) are indicated by solid lines, and the event signals 123 generated at other times are depicted by dotted lines. As described above, since the event signal 123 is generated asynchronously in time, in the case where the event signal 123 is not generated at the predetermined time described above, for example, the event signal 123 to which the timestamp 124 of a close time is given is used.

As depicted in FIG. 5, the RGB image signal 113 is generated at a predetermined cycle, while the event signal 123 is generated asynchronously in time. In addition, the event signal 123 is generated at a frequency significantly higher than the generation frequency of the RGB image signal 113 (the frame rate of the RGB camera 11).

In addition, Ir[t1] that is the RGB image signal 113 having a timestamp of t1 is generated later than time t1, and Ie[t1] that is the event signal 123 having a timestamp of t1 is generated approximately at the time t1. That is, the event signal 123 is relatively high in immediacy and is generated only when a change in luminance is detected. Meanwhile, the RGB image signal 113 is generated later than the event signal 123 at an approximately constant cycle.

At the timing when the RGB image signal 113 is generated, the detection section 21 detects the attention point on the basis of the RGB image signal 113, calculates the correction value on the basis of the event signal 123, and corrects the attention point detected on the basis of the RGB image signal 113. A certain period of time is required for detection of the attention point by the detection section 21, and D[t1] that indicates a detection result having a timestamp of t1 is output, for example, at time t2. That is, the detection result of the attention point based on the RGB image signal 113 is generated later than the generation of the RGB image signal 113 at an approximately constant cycle. It should be noted that, in FIG. 5, for the purpose of explanation, it is assumed that the detection result obtained by the detection section 21 is output with a delay of one frame with respect to the frame rate of the RGB camera 11.

Here, the RGB image signal 113 has a larger amount of information than the event signal 123 and includes information of a stationary part unlike the event signal 123. Therefore, the detection section 21 detects the attention point on the basis of the RGB image signal 113, so that the detection can be performed with high accuracy. However, as described above, the event signal 123 is generated at a frequency higher than the generation frequency of the RGB image signal 113 (the frame rate of the RGB camera 11). That is, since the RGB image signal 113 is generated at a lower frequency than the event signal 123, the temporal resolution is inferior.

Thus, the detection section 21 selects whether to refer to the RGB image signal 113 or whether to refer to the event signal 123 when detecting the attention point according to the timing when the RGB image signal 113 is generated as described above.

For example, in the example of FIG. 5, the detection result D[t1] by the detection section 21 is output at the time t2 on the basis of the RGB image signal 113 (Ir[t1] ) having a timestamp of t1. Thereafter, it is possible to estimate that the detection result is correct for a predetermined period of time, but in the case where the timing of generation of the RGB image signal 113 and output of the detection result obtained by the detection section 21 is not reached thereafter in spite of, for example, a movement of the attention point, there is a possibility that the movement of the attention point occurring during the time cannot be captured.

Therefore, when a predetermined period of time elapses after the generation of the RGB image signal 113, the detection section 21 refers to the event signal 123 when detecting the attention point. It should be noted that the predetermined period of time may be fixed or may be set each time. For example, the predetermined period of time may be set according to the frame rate of the RGB camera 11 or may be set on the basis of a user operation. Further, the predetermined period of time may be approximately 0. In this case, the detection of the attention point based on the RGB image signal 113 may be started, or the detection of the attention point based on the event signal 123 may be started immediately after the start.

As described above, the RGB image signal 113 is generated later than the event signal 123. That is, the event signal 123 is generated prior to the RGB image signal 113. Therefore, when detecting the attention point, the detection section 21 refers to the event signal 123 that is generated with temporal correlation with time for specifying the RGB image signal 113 referred to by the detection section 21.

For example, in the example of FIG. 5, the detection section 21 outputs the detection result D[t1] on the basis of the RGB image signal 113 (Ir[t1]) having a timestamp of t1 at the time t2, and after a predetermined period of time elapses, detection is performed on the basis of the event signals 123 including the event signal 123 (Ie[t1]) generated in advance and having a timestamp of t1. In the detection of the attention point based on the event signal 123, the detection section 21 performs detection by, for example, calculating an optical flow indicating the movement of the attention point on the basis of a plurality of event signals 123.

That is, in FIG. 5, in the period indicated by an arrow A1 from the output of the detection result D[t1] of the attention point based on the RGB image signal 113 (Ir[t1] ) to the output of the detection result D[t2] of the attention point based on the RGB image signal 113 (Ir[t2]), detection is performed on the basis of the event signals 123 including the event signal 123 (Ie[t1] ) to which a timestamp associated with the timestamp given to the RGB image signal 113 (Ir[t1] ) is given, as indicated by the period of an arrow A2.

Then, the detection result D[t2] is output by the detection section 21 at time t3 on the basis of the RGB image signal 113 (Ir[t2] ) having a timestamp of t2. Thereafter, either detection of the attention point based on the RGB image signal 113 or detection of the attention point based on the event signal 123 is similarly executed.

It should be noted that the above-described optical flow may appropriately utilize the optical flow calculated when calculating the correction value on the basis of the event signal 123 described in the first embodiment.

In addition, the event signals 123 generated in advance preferably include the event signal 123 to which a timestamp matching the timestamp given to the RGB image signal 113 is given, or the event signal 123 to which a timestamp indicating a time earlier than the timestamp given to the RGB image signal 113 is given, but these event signals 123 may be accumulated in a buffer or recorded as image data. For example, in the case where the event signals 123 are grouped by timestamps within the same or fixed range and the event signals 123 are accumulated in a buffer as data indicating the presence or absence of an event, the polarity of the event, and the like, processing can be performed on an event basis when referring to later.

Hereinafter, a case where the event signals 123 are accumulated in a buffer, which is not illustrated, in the detection section 21 will be described as an example.

In addition, in the case where the position of the interest region R is significantly different when the target to be referred to by the detection section 21 when detecting the attention point is changed from the event signal 123 to the RGB image signal 113, the interest region R abruptly changes. In such a case, the detection section 21 may be configured to change the interest region R gradually or stepwise. Further, a difference between the detection result of the attention point based on the event signal 123 and the detection result of the attention point based on the RGB image signal 113 may be obtained, and the method of changing the interest region R may be changed according to the difference.

As described above, the detection section 21 detects the attention point on the basis of the RGB image signal 113 according to the timing when the RGB image signal 113 is generated, and detects the attention point on the basis of the event signal 123 in at least a part of the period until the RGB image signal 113 is newly generated next. Therefore, it is possible to perform detection using the RGB image signal 113 preferentially at the timing when the detection result of the attention point based on the RGB image signal 113 is output after the RGB image signal 113 is generated and to perform detection using the event signal 123 supplementarily for the period until the RGB image signal 113 is generated next. In the detection of the attention point based on the event signal 123, since the position itself of the event signal 123 in a region associated with the set interest region R corresponds to the coordinate information of the attention point, the detection section 21 can detect the attention point with high accuracy on the basis of the position where the event signal 123 has occurred, the polarity, and the like.

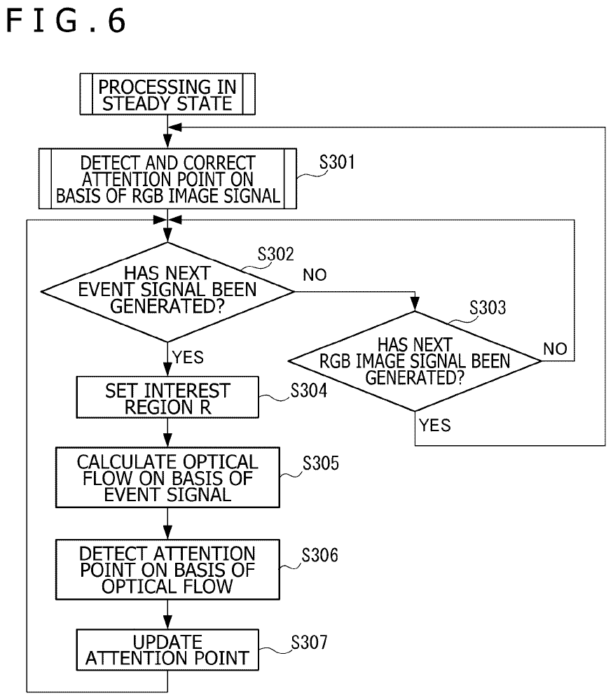

FIG. 6 is a flowchart for depicting an example of processing according to the second embodiment of the present invention, and is a flowchart in the processing in the steady state corresponding to FIG. 4 of the first embodiment. It should be noted that, since the entire processing except the processing in the steady state is similar to that in the flowchart of FIG. 3 in the first embodiment, the illustration and explanation thereof will be omitted.

In the example of FIG. 6, the detection section 21 performs the processing similar to the processing from Step S201 to Step S206 of FIG. 4 in the first embodiment in the processing in the steady state, so that the attention point is detected on the basis of the RGB image signal 113, the correction value is calculated on the basis of the event signal 123, and the attention point detected on the basis of the RGB image signal 113 is corrected (Step S301).

Next, the detection section 21 determines whether or not the event signal 123 has been generated by the EVS 12 (Step S302), and if it is determined that the event signal 123 is not generated after a predetermined period of time elapses (NO in Step S302), the detection section 21 determines whether or not the RGB image signal 113 has been generated by the RGB camera 11 (Step S303), and if it is determined that the next RGB image signal 113 has been generated (YES in Step S303), the detection section 21 returns to Step S301. That is, the detection section 21 repeatedly executes the processing from Step S301 each time the RGB image signal 113 is generated.

In contrast, if it is determined that the RGB image signal 113 is not generated after a predetermined period of time elapses (NO in Step S303), the detection section 21 returns to Step S302.

If it is determined in Step S302 that the event signal 123 has been generated (YES in Step S302), the detection section 21 sets the interest region R (Step S304).

Next, the detection section 21 calculates an optical flow on the basis of the event signal 123 (Step S305), and detects the attention point in the interest region R (Step S306). Then, the detection section 21 updates the target of detection to the attention point newly detected in Step S306 (Step S307).

That is, the detection section 21 repeatedly executes the processing from Step S302 to Step S307 each time the event signal 123 is generated.

It should be noted that, in the case where a plurality of interest regions are set, each section executes the processing from Steps S301 to S307 for each of the plurality of interest regions.

In addition, the detection and correction of the attention point based on the RGB image signal 113 in Step S301 includes the following two patterns of processing.

### (1) Processing of Step S301 for the First Time

In the processing of Step S301 for the first time, the detection section 21 detects the attention point on the basis of the RGB image signal 113 that is the target of determination in Step S107 of the initial processing procedure described in FIG. 3 of the first embodiment, and performs correction on the basis of the event signal 123 selected in Step S108.

### (2) Processing of Step S301 From the Second Time

In the processing of Step S301 from the second time, the detection section 21 detects the attention point on the basis of the RGB image signal 113 that is the target of determination in previous Step S303 in the processing in the steady state described with reference to FIG. 6, calculates the correction value on the basis of the event signal 123 generated with temporal correlation, and performs correction. At this time, the detection section 21 may consider information of the previously detected attention point. That is, the detection section 21 does not detect the attention point on the basis of only the RGB image signal 113 that is the target of determination in previous Step S303, but may use information of the previously detected attention point. For example, the information of the previously detected attention point may be used to narrow down the region in which the attention point is detected this time. In addition, for example, detection of the attention point may be performed by reflecting the both information such as appropriately performing weighting and addition according to the difference between the position of the previously detected attention point and the position of the attention point detected on the basis of only the RGB image signal 113 that is the target of determination in previous Step S303.

In addition, the setting of the interest region R in Step S304 includes the following two patterns of processing.

### (1) Processing of Step S304 for the First Time

In the processing of Step S304 for the first time, the detection section 21 sets the interest region R for each attention point detected and corrected in Step S301.

### (2) Processing of Step S304 From the Second Time

In the processing of Step S304 from the second time, the detection section 21 sets the interest region R for each attention point updated in previous Step S307.

In the processing in the steady state, the detection section 21 complementarily executes the detection of the attention point based on the RGB image signal 113 and the detection of the attention point based on the event signal 123 at an appropriate timing by repeating the processing from Steps S301 to S307. Therefore, the detection can be performed with high accuracy while suppressing latency.

It should be noted that, in the processing in the steady state, as described above, first processing from Step S301 to Step S303, which is repeatedly executed each time the RGB image signal 113 is generated, and second processing from Step S302 to Step S307, which is executed each time the event signal 123 is generated, are complementarily executed, but the cycle of the second processing is generally faster than the cycle of the first processing. This is because the event signal 123 is generated at a frequency significantly higher than the generation frequency of the RGB image signal 113 (the frame rate of the RGB camera 11) as described above.

In the second embodiment of the present invention as described above, the attention point in the detection target is detected on the basis of, in addition to the RGB image signal 113 that is an output of the first sensor (image sensor 111), the event signal 123 generated with temporal correlation with time for specifying the RGB image signal 113 among the event signals 123 generated by the second sensor (sensor 121).

Thus, detection can be performed by preferentially utilizing the RGB image signal 113 that is an output of the first sensor, and detection can be supplementally performed on the basis of the event signal 123 that is relatively high in temporal resolution. That is, the detection result of the attention point based on the output of the first sensor is interpolated with the detection result of the attention point based on the event signal 123 that has been generated temporally in advance. Therefore, in addition to the effects described in the first embodiment, since the detection of the attention point based on the event signal 123 can be performed prior to the output of the detection result of the attention point based on the output of the first sensor, it is possible to detect quick motion and smooth movement of the attention point in comparison with the detection using only the RGB image signal 113 that is the output of the first sensor and the detection in which linear interpolation is applied to the RGB image signal 113. Thus, the detection can be performed with high accuracy while latency is suppressed.

### Third Embodiment

Hereinafter, a third embodiment of the present invention will be described with reference to the drawings. In the third embodiment, only the parts different from those in the first embodiment and the second embodiment will be described, and the description of the parts similar to those in the first embodiment and the second embodiment will be omitted. In addition, in the third embodiment, the constitutional elements having substantially the same functional configurations as those in the first embodiment and the second embodiment will be denoted by the same reference signs.

In the third embodiment, the detection section 21 detects the attention point on the basis of the event signal 123 generated by the sensor 121 that is the second sensor, in addition to the RGB image signal 113 generated by the image sensor 111 that is the first sensor as in the second embodiment. Then, when detecting the attention point on the basis of the event signal 123, processing according to the nature of the event signal 123 is performed.

As described above, the event signal 123 is generated when a change in the intensity of light incident on each pixel, more specifically, a change in luminance exceeding a preset predetermined value is detected. Therefore, the generation frequency of the event signal 123 depends on the amount of movement of an object. For example, the generation frequency of the event signal 123 largely differs among an object that slowly moves, an object that quickly moves, and a stationary object that does not move. In addition, the generation frequency of the event signal 123 also depends on the texture of an object. For example, the generation frequency of the event signal 123 becomes high in the case of an object having a reflective surface such as a window on the surface, or a texture having many irregularities such as ornamentation.

Therefore, it is preferable to perform detection of the attention point on the basis of the event signal 123 at the generation frequency of the event signal 123 and at the timing when the amount of the event signals 123 suitable for detection of the attention point based on the event signal 123 is generated.

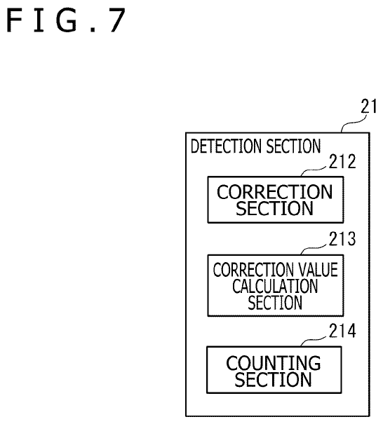

FIG. 7 is a block diagram for depicting an outline configuration of the detection section 21. As depicted in FIG. 7, the detection section 21, in addition to the correction section 212 and the correction value calculation section 213, is provided with a counting section 214.

The counting section 214 counts the amount of events of the event signals 123 in the attention region associated with the interest region on the basis of the event signals 123. Here, the amount of events is, for example, the number of event signals 123 per unit time. If it is determined that the number of event signals 123 counted by the counting section 214 within a predetermined period exceeds a predetermined threshold value, the detection section 21 detects the attention point on the basis of the event signals 123.

It should be noted that the amount of events is not limited to the number of event signals 123 per unit time described above. For example, the distribution of the event signals 123 may be calculated by performing weighting processing on the basis of a distance from the center of each attention region to the event signal 123 and the like, and the calculated distribution may be used as the amount of events. When the distribution is calculated, the distribution may be calculated on a logarithmic scale. By calculating the distribution in this way, it is possible to calculate the distribution in which the influence of a change in ambient brightness is suppressed. In particular, by calculating the distribution on a logarithmic scale, it is possible to calculate accurate distribution even in a dark scene at which the EVS 12 is not good.

In addition, in the case where a plurality of interest regions are set, the counting section 214 sets each of the plurality of interest regions as the attention region, and counts the number of event signals 123 for each attention region.

In the case where the amount of events counted by the counting section 214 satisfies a predetermined condition, the detection section 21 detects the attention point on the basis of the event signal 123. At this time, the detection section 21 detects the attention point on the basis of the event signal 123 at a shorter time interval as the amount of events is larger, and detects the attention point on the basis of the event signal 123 at a longer time interval as the amount of events is smaller.

As described above, the timing suitable for detecting the attention point on the basis of the event signal 123 differs depending on an object. The counting section 214 counts the amount of events for each attention region associated with the interest region, and in the case where the amount of counted events satisfies a predetermined condition, the attention point is detected on the basis of the event signal 123, so that suitable detection can be performed according to characteristics such as the speed of movement of an object and characteristics such as texture for each interest region.

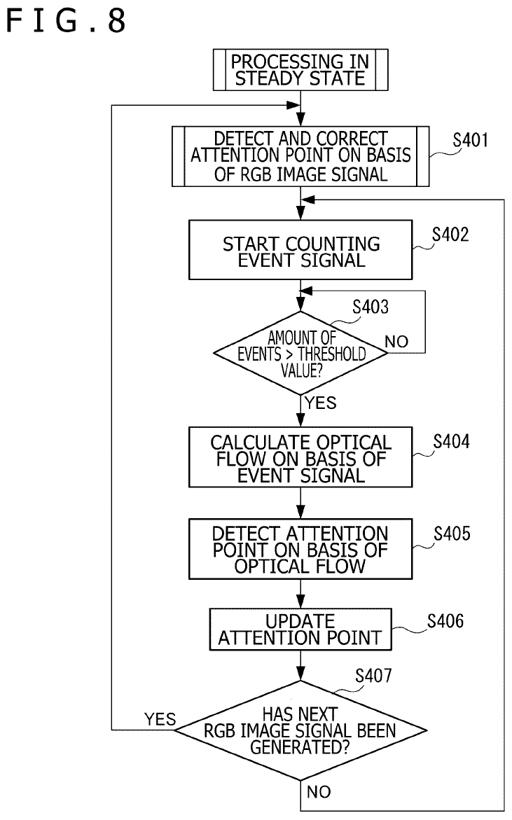

FIG. 8 is a flowchart for depicting an example of processing according to the third embodiment of the present invention, and is a flowchart in the processing in the steady state corresponding to FIG. 4 of the first embodiment and FIG. 6 of the second embodiment. It should be noted that, since the entire processing except the processing in the steady state is similar to that in the flowchart of FIG. 3 in the first embodiment, the illustration and explanation thereof will be omitted.

In the example of FIG. 8, the detection section 21 performs the processing similar to the processing from Step S201 to Step S206 of FIG. 4 in the first embodiment in the processing in the steady state, so that the attention point is detected on the basis of the RGB image signal 113, the correction value is calculated on the basis of the event signal 123, and the attention point detected on the basis of the RGB image signal 113 is corrected (Step S401).

Next, the counting section 214 starts counting the amount of events of the event signals 123 in the attention region associated with the interest region (Step S402), and determines whether or not the amount of events has exceeded a threshold value (Step S403).

Then, if the amount of events exceeds the threshold value (YES in Step S403), the detection section 21 determines that the amount of counted events satisfies a predetermined condition, calculates an optical flow on the basis of the event signal 123 (Step S404), and detects the attention point in the interest region R (Step S405). Then, the detection section 21 updates the target of detection to the attention point newly detected in Step S405 (Step S406).

The detection section 21 determines whether or not the RGB image signal 113 has been generated by the RGB camera 11 (Step S407), and if it is determined that the RGB image signal 113 has been generated (YES in Step S407), the flow returns to Step S401. Meanwhile, if it is determined that the RGB image signal 113 is not generated after a predetermined period of time elapses (NO in Step S407), the detection section 21 returns to Step S402. That is, until the RGB image signal 113 is generated, the detection section 21 repeatedly executes the processing from Steps S402 to S408 to detect the attention point on the basis of the event signal 123 at a suitable timing. Then, each time the RGB image signal 113 is generated, the processing from Step S401 to Step S407 is repeatedly executed.

It should be noted that, in the case where a plurality of interest regions are set, each section executes the processing from Steps S401 to S407 for each of the plurality of interest regions.

In the third embodiment of the present invention described above, the counting section 214 for counting the amount of events of the event signals 123 in the attention region including the attention point based on the event signals 123 is provided, and the detection section 21 detects the attention point on the basis of at least the event signals 123 in the case where the amount of events counted within a predetermined period satisfies a predetermined condition. Thus, in addition to the effects described in the first embodiment, detection of the attention point based on the event signal 123 can be performed at an optimum timing. In addition, detection of the attention point can be performed with high accuracy for various objects by making the timing of detection of the attention point variable. In addition, in the third embodiment of the present invention, the detection section 21 detects a plurality of attention points, the counting section 214 counts the amount of events for each of a plurality of attention regions, and the detection section 21 detects the attention point for each of the plurality of attention regions on the basis of at least the event signal 123 according to the timing for satisfying a predetermined condition. Therefore, the attention point can be detected in accordance with the characteristics of each of the plurality of attention points.

### Modification Examples

It should be noted that, in the first embodiment of the present invention described above, the image sensor 111 that is an image sensor for generating image signals is exemplified as the first sensor, but the present invention is not limited to this example. For example, the first sensor may be an image sensor for generating image signals other than the RGB image signal 113. In addition, the first sensor may be a sensor other than the image sensor.

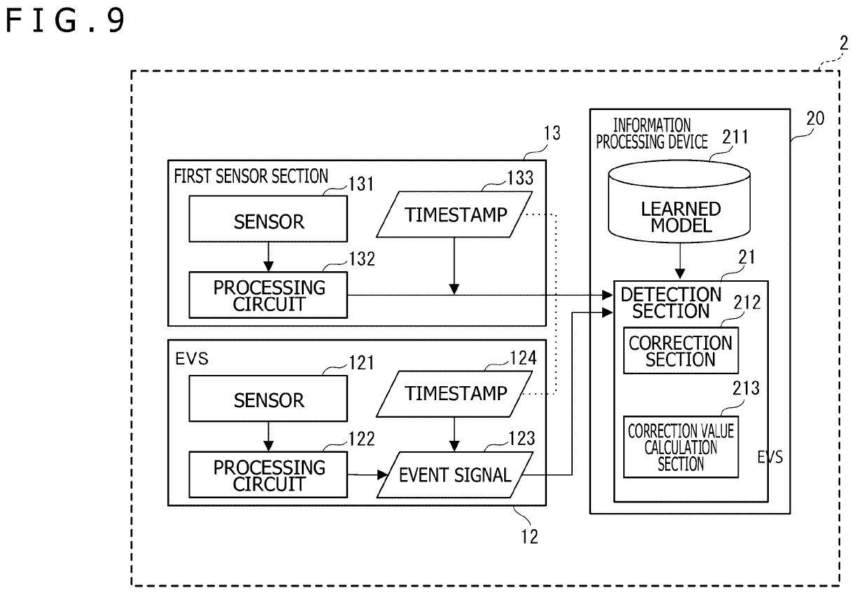

FIG. 9 is another block diagram for depicting an outline configuration of a system according to each embodiment of the present invention.

As depicted in FIG. 9, a system 2 includes a first sensor section 13 instead of the RGB camera 11 of the system 1 described in FIG. 1. It should be noted that, in the following description, parts that are the same or substantially the same as those already described are denoted by the same reference signs and the description thereof is omitted.

The first sensor section 13 includes a sensor 131 that is a first sensor and a processing circuit 132. Then, the sensor 131 acquires information related to the detection of the attention point, for example, at a predetermined cycle or at a predetermined timing according to a user operation. As the sensor 131, for example, a depth sensor for detecting a three-dimensional structure, a sensor for acquiring position information from a global positioning system (GPS) satellite, a sensor for imaging a non-repetitive pattern such as an augmented reality (AR) marker used for position estimation, an inertial measurement unit (IMU) that is a sensor for detecting a posture, a sensor for self-position estimation by simultaneously localization and mapping (SLAM), and the like can be applied. The processing circuit 132 converts an output of the sensor 131 into a format suitable for storage and transmission. In addition, the processing circuit 132 gives a timestamp 133 to the output of the sensor 131. Hereinafter, the output of the sensor 131 converted by the processing circuit 132 and given the timestamp 133 is referred to as an “output of the sensor 131.”

In the system 2, the timestamp 133 given to the output of the sensor 131 and the timestamp 124 given to the event signal 123 are temporally associated with each other. Specifically, for example, time information used for generating the timestamp 124 by the EVS 12 is provided to the first sensor section 13, so that the timestamp 133 can be associated with the timestamp 124. Alternatively, in the case where the time information used for generating the timestamps 133 and 124 is independent between the first sensor section 13 and the EVS 12, the offset amount of the timestamps is calculated on the basis of the time when a specific event (for example, a change in a subject throughout an image) occurred, so that the timestamp 133 and the timestamp 124 can be associated with each other after the occurrence.

In addition, in the system 2, the sensor 121 of the EVS 12 and the sensor 131 of the first sensor section 13 are associated with each other by the calibration procedures of the first sensor section 13 and the EVS 12, which are executed in advance, as similar to the system 1 described in FIG. 1.

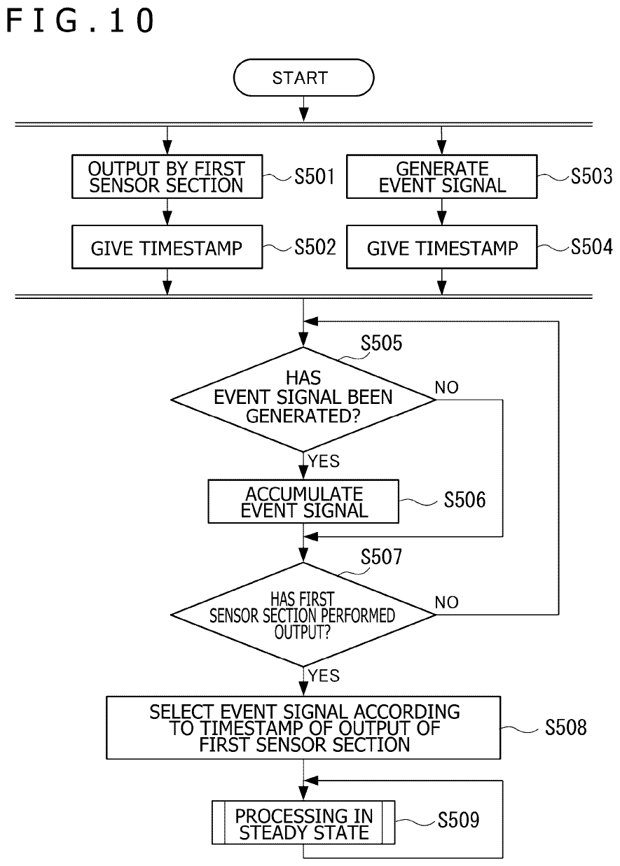

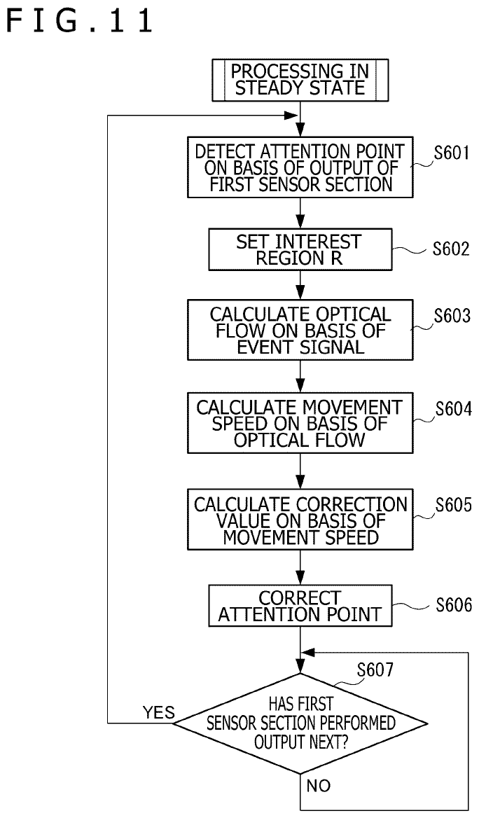

FIG. 10 and FIG. 11 are flowcharts for depicting an example of processing in the system 2. It should be noted that FIG. 10 corresponds to the flowchart of FIG. 4 of the first embodiment described in relation to the system 1 and FIG. 11 corresponds to the flowchart of FIG. 5 of the first embodiment described in relation to the system 1. In the following description, description of parts that are the same or substantially the same as those in each flowchart will be omitted.

In the example of FIG. 10, the first sensor section 13 performs an output (Step S501), and the timestamp 133 is given to the output of the first sensor section 13 (Step S502).

Step S503 to Step S506 are similar to Step S103 to Step S106 in FIG. 3 of the first embodiment, respectively.

The detection section 21 determines whether or not the output has been performed by the first sensor section 13 (Step S507), and if it is determined that the output has been performed by the first sensor section 13 (YES in Step S507), the flow proceeds to Step S508 to be described later. Meanwhile, if it is determined that the output is not performed by the first sensor section 13 after a predetermined period of time elapses (NO in Step S507), the detection section 21 returns to Step S505. That is, until the output is performed by the first sensor section 13, the detection section 21 accumulates the event signal 123 in a buffer, which is not illustrated, each time the event signal 123 is generated.

If it is determined that the output has been performed by the first sensor section 13 (YES in Step S507), the detection section 21 selects a part of the event signals 123 among those accumulated in the buffer according to the timestamp 133 given to the output by the first sensor section 13 (Step S508). The detection section 21 refers to the timestamp 133 given to the output by the first sensor section 13 and the timestamp 124 given to the event signal 123, and selects the event signal 123 generated with temporal correlation with time for specifying the output by the first sensor section 13.

The series of processing from Step S505 to Step S508 described so far is an initial processing procedure for allowing the output by the first sensor section 13 and the event signal 123 to have temporal correlation. The method of the initial processing procedure is not limited to this example.

Then, the detection section 21 executes processing in the steady state (Step 509).

In the example of FIG. 11, in the processing in the steady state described in Step S509 in FIG. 10, the detection section 21 detects the attention point on the basis of the output by the first sensor section 13 (Step S601), and sets the interest region R for each detected attention point (Step S602).

Step S603 to Step S606 are similar to Step S203 to Step S206 in FIG. 4 of the first embodiment, respectively.

Next, the detection section 21 determines whether or not the output has been performed by the first sensor section 13 (Step S607), and if it is determined that the next output has been performed by the first sensor section 13 (YES in Step S607), the flow returns to Step S601. That is, the detection section 21 repeatedly executes the processing from Step S601 to Step S607 each time the next output is performed by the first sensor section 13.

According to the system 2, as similar to the system 1 described above, the attention point in the detection target is detected on the basis of the output of the first sensor (sensor 131), the correction value is calculated on the basis of the event signal 123 generated with temporal correlation with time for specifying the output of the first sensor among the event signals 123 generated by the second sensor (sensor 121), and the detection result is corrected on the basis of the correction value.

Thus, it is possible to detect the attention point on the basis of the output of the first sensor and calculate the correction value for correcting the detection result on the basis of the event signal 123 generated with temporal correlation. That is, the detection result of the attention point based on the output of the first sensor is corrected on the basis of the event signal 123 acquired independently of and with temporal correlation with the output of the first sensor. Therefore, even in the case where the detection result of the attention point based on the output of the first sensor includes the jitter that is a temporal deviation or fluctuation, the jitter can be corrected or suppressed. Thus, the detection can be performed with high accuracy.

It should be noted that, even in the second embodiment and the third embodiment, an image sensor for generating image signals other than the RGB image signal 113 may be similarly provided as the first sensor, or a sensor other than the image sensor may be provided.

Further, in the second embodiment, the detection section 21 is only required to detect the attention point on the basis of the output of the first sensor section 13 in Step S301 described in FIG. 6, and it is only required to determine, in Step S303, whether or not the first sensor section 13 has performed the output. Similarly, in the third embodiment, the detection section 21 is only required to detect the attention point on the basis of the output of the first sensor section 13 in Step S401 described in FIG. 8, and it is only required to determine, in Step S408, whether or not the first sensor section 13 has performed the output.

In addition, the detection result described in each of the above embodiments may be used in any manner. For example, by using the detection result for tracking, it is also useful for a rendering system that uses a user movement for depiction of a computer graphics (CG) model, a mirroring system that reproduces a user movement by a robot or the like, a gaming system that accepts a user operation similar to controllers, and the like. For example, in the case where the present invention is used for a rendering system, it becomes possible to perform more detailed and highly accurate detection and tracking, and thus it becomes possible to improve reproducibility of motion in a CG model.

In addition, the present invention can be similarly applied to, for example, detection of the attention point in which a predetermined vehicle, machine, living substance, or the like other than a person is the detection target, or detection of the attention point in which a predetermined marker or the like is the detection target.

In addition, in the detection section 21 in the information processing device 20 described in each of the above embodiments, an example of detecting the attention point from the RGB image signal 113 by using the machine learning method has been depicted, but the present invention may have a configuration in which the attention point is detected by using other methods instead of or in addition to machine learning. For example, the attention point may be detected by using a known method such as a block matching method or a gradient method.

In addition, the system 1 described in each of the above embodiments may be implemented in a single device or may be implemented by being distributed in a plurality of devices. For example, the system may be provided with a camera unit including the RGB camera 11 and the EVS 12 and the information processing device 20. In addition, the information processing device 20 may be implemented in a single device or may be implemented by being distributed in a plurality of devices. For example, a part or all of the processing performed by the detection section 21 may be executed by a server communicably connected by an Internet communication network or wireless communication.

Although several embodiments of the present invention have been described in detail with reference to the accompanying drawings, the present invention is not limited to these examples. It is obvious that a person who has ordinary knowledge in the field of the technique to which the present invention belongs can arrive at various modification examples or correction examples within the scope of the technical thought described in the claims, and it is understood that these examples also naturally belong to the technical scope of the present invention.

### Summary of the Present Invention

[1]

An information processing device including:
a detection section that detects an attention point in a detection target on the basis of an output of a first sensor;
a correction section that corrects a detection result obtained by the detection section; and
a correction value calculation section that calculates a correction value in the correction section on the basis of an event signal generated with temporal correlation with time for specifying the output of the first sensor among event signals generated by a second sensor including an event-based sensor for asynchronously generating event signals when detecting a change in intensity of light incident on each pixel.
   [2]

The information processing device according to [1], in which
the detection section calculates coordinate information of the attention point, and
the correction section corrects the coordinate information.
   [3]

The information processing device according to [1] or [2], in which
the correction value calculation section calculates an optical flow indicating a movement of the attention point on the basis of a plurality of the event signals, and calculates the correction value on the basis of the optical flow.
   [4]

The information processing device according to [3], in which
the correction value calculation section calculates a movement speed of the attention point on the basis of the optical flow, makes a degree of correction by the correction section smaller as the movement speed is larger, and makes the degree of correction larger as the movement speed is smaller.
   [5]

The information processing device according to any one of [1] to [4], in which
the correction section performs filter processing on the attention point, and
the correction value calculation section calculates a cutoff frequency in the filter processing as the correction value.
   [6]

The information processing device according to [5], in which
the correction section executes the filter processing by a low-pass filter.
   [7]

The information processing device according to any one of [1] to [6], in which
the detection target is a person, and
the detection section detects at least one joint of the person as the attention point.
   [8]

The information processing device according to any one of [1] to [7], in which,
in addition to the output of the first sensor, the detection section detects the attention point on the basis of the event signal generated with temporal correlation with time for specifying the output of the first sensor among the event signals.
   [9]

The information processing device according to any one of [1] to [8], including:
a counting section that counts an amount of events of the event signals in an attention region including the attention point within a predetermined period on the basis of the event signals, in which,
in a case where the amount of events counted within the predetermined period satisfies a predetermined condition, the detection section detects the attention point on the basis of at least the event signal.
   [10]

The information processing device according to [9], in which
the detection section detects a plurality of the attention points,
the counting section counts the amount of events for each of a plurality of the attention regions, and
the detection section detects the attention point for each of the plurality of attention regions on the basis of at least the event signal, according to a timing satisfying the predetermined condition.
   [11]

The information processing device according to [9] or [10], in which
the amount of events is the number of event signals per unit time, and,
in a case where the number of event signals exceeds a predetermined threshold value, the detection section detects the attention point on the basis of at least the event signal.
   [12]

The information processing device according to any one of [1] to [11], in which the first sensor includes an image sensor for generating an image signal.

[13]

A system including:
a first sensor;
a second sensor that includes an event-based sensor for asynchronously generating event signals when detecting a change in intensity of light incident on each pixel;
a detection section that detects an attention point in a detection target on the basis of an output of the first sensor;
a correction section that corrects a detection result obtained by the detection section; and
a correction value calculation section that calculates a correction value in the correction section on the basis of the event signal generated with temporal correlation with time for specifying the output of the first sensor among the event signals.
   [14]

An information processing method including:
a first reception step of receiving an output of a first sensor;
a second reception step of receiving event signals generated by a second sensor including an event-based sensor for asynchronously generating event signals when a change in intensity of light incident on each pixel is detected;
a detection step of detecting an attention point in a detection target on the basis of the output of the first sensor;
a correction step of correcting a detection result in the detection step; and
a correction value calculation step of calculating a correction value in the correction step on the basis of the event signal generated with temporal correlation with time for specifying the output of the first sensor among the event signals.
   [15]

An information processing program that causes a computer to realize:
a function of receiving an output of a first sensor;
a function of receiving event signals generated by a second sensor including an event-based sensor for asynchronously generating event signals when a change in intensity of light incident on each pixel is detected;
a function of detecting an attention point in a detection target on the basis of the output of the first sensor;
a function of correcting the detected attention point; and
a function of calculating a correction value when a detection result is corrected, on the basis of the event signal generated with temporal correlation with time for specifying the output of the first sensor among the event signals.
   [16]

A computer system including:
at least one memory for storing a program code; and
at least one processor for processing the program code to execute an operation, in which
the operation includes
receiving an output of a first sensor,
receiving event signals generated by a second sensor including an event-based sensor for asynchronously generating event signals when a change in intensity of light incident on each pixel is detected,
detecting an attention point in a detection target on the basis of the output of the first sensor,
correcting the detected attention point, and
calculating a correction value when a detection result is corrected, on the basis of the event signal generated with temporal correlation with time for specifying the output of the first sensor among the event signals.

### REFERENCE SIGNS LIST

1, 2: System
11: RGB camera
12: EVS
13: First sensor section
20: Information processing device
21: Detection section
111: Image sensor
112, 122: Processing circuit
113: RGB image signal
114, 124, 133: Timestamp
121, 131: Sensor
123: Event signal
211: Learned model
212: Correction section
213: Correction value calculation section
214: Counting section

1. (canceled)

2. The information processing method according to claim 14, further comprising:
calculating coordinate information of the attention point, and
correcting the coordinate information.

3. The information processing method according to claim 14, further comprising:
calculating an optical flow indicating a movement of the attention point on a basis of a plurality of the event signals; and
calculating the correction value on a basis of the optical flow.

4. The information processing method according to claim 3, further comprising:
calculating a movement speed of the attention point on a basis of the optical flow;
adjusting a degree of correction corresponding to a value of the movement speed.

5. The information processing method according to claim 14, further comprising:
performing a filter processing on the attention point; and
calculating a cutoff frequency in the filter processing as the correction value.

6. The information processing method according to claim 4, further comprising executing the filter processing by a low-pass filter.

7. The information processing method according to claim 14, wherein the detection target is a person and the information processing method further comprises detecting at least one joint of the person as the attention point.

8. The information processing method according to claim 14, further comprising in addition to the output of the first sensor, detecting the attention point on the basis of the event signal generated with temporal correlation with time for specifying the output of the first sensor among the event signals.

9. The information processing method according to claim 14, further comprising:
counting an amount of events of the event signals in an attention region including the attention point within a predetermined period on a basis of the event signals; and
in a case where the amount of events counted within the predetermined period satisfies a predetermined condition, detecting the attention point on a basis of at least the event signal.

10. The information processing method according to claim 9, further comprising:
detecting a plurality of attention points, wherein the attention point is one of the plurality of attention points;
counting the amount of events for each of a plurality of attention regions; and
detecting the attention point for each of the plurality of attention regions on the basis of at least the event signal according to a timing satisfying the predetermined condition.

11. The information processing method according to claim 9, wherein the amount of events is a number of event signals per unit time and, in a case where the number of event signals exceeds a predetermined threshold value, the information processing method further comprises detects the attention point on the basis of at least the event signal.

12. The information processing method according to claim 14, wherein the first sensor includes an image sensor for generating an image signal.

13. (canceled)

14. An information processing method comprising:
receiving an output of a first sensor;
receiving event signals generated by a second sensor including an event-based sensor for asynchronously generating event signals when a change in intensity of light incident on each pixel is detected;
detecting an attention point in a detection target on a basis of the output of the first sensor;
correcting a detection result in the attention point; and
calculating, based at least in part on the detection result, a correction value on a basis of the event signal generated with temporal correlation with time for specifying the output of the first sensor among the event signals.

15. One or more non-transitory computer-readable media comprising computer-executable instructions that, when executed by one or more processors of an electronic device, cause the electronic device to perform operations comprising:
by a detection section of the electronic device, receiving an output of a first sensor;
by the detection section of the electronic device, receiving event signals generated by a second sensor including an event-based sensor for asynchronously generating event signals when a change in intensity of light incident on each pixel is detected;
by the detection section of the electronic device, detecting an attention point in a detection target on a basis of the output of the first sensor;
by a correction section of the electronic device, correcting the detected attention point; and
by a correction value calculation section of the electronic device, calculating a correction value when a detection result is corrected, on a basis of the event signal generated with temporal correlation with time for specifying the output of the first sensor among the event signals.

16. A computer system comprising:
at least one memory comprising computer-executable instructions; and
at least one processor configurated to access the at least one memory and execute the computer-executable instructions to perform operations comprising:
receiving an output of a first sensor;
receiving event signals generated by a second sensor including an event-based sensor for asynchronously generating event signals when a change in intensity of light incident on each pixel is detected;
detecting an attention point in a detection target on a basis of the output of the first sensor;
correcting the detected attention point; and
calculating a correction value when a detection result is corrected, on a basis of the event signal generated with temporal correlation with time for specifying the output of the first sensor among the event signals.

17. The information processing method of claim 4, wherein adjusting the degree of correction includes adjusting the degree of correction to a larger value where the value of the movement speed is smaller.

18. The information processing method of claim 4, wherein adjusting the degree of correction includes adjusting the degree of correction to a smaller value where the value of the movement speed is larger.
